(19) United States
(12) Patent Application Publication
(10) Pub. No.: US 2026/0321595 A1
(43) Pub. Date: Oct. 15, 2026

(54) COMPOSITE NEGATIVE ELECTRODE, PREPARATION METHOD THEREFOR, AND BATTERY

(71) Applicant: MICROVAST, INC, Stafford, TX (US)

(72) Inventors: Haojun QI, Huzhou (CN); Daohui LI, Huzhou (CN); Weifeng FANG, Huzhou (CN); Wenjuan Liu MATTIS, Stafford, TX (US)

(73) Assignee: MICROVAST, INC, Stafford, TX (US)

(21) Appl. No.: 19/175,607

(22) Filed: Apr. 10, 2025

(51) Int. Cl. H01M 4/36; H01M 4/02; H01M 4/04; H01M 4/38; H01M 4/587; H01M 4/62; H01M 10/0525

(52) U.S. Cl. CPC H01M 4/366; H01M 4/0435; H01M 4/382; H01M 4/386; H01M 4/587; H01M 2004/021; H01M 4/625; H01M 10/0525

(57) ABSTRACT

A composite negative electrode, a preparation method therefor, and a battery are provided. The composite negative electrode includes a substrate and a negative electrode coating layer provided on the substrate. The negative electrode coating layer includes a first material and a second material, the first material is a lithium-containing material, and in a direction away from the substrate along the composite negative electrode, the content of the lithium-containing material in at least part of the composite negative electrode gradually increases.

### TECHNICAL FIELD

The present invention relates to the field of lithium metal batteries, and in particular, to a composite negative electrode, a preparation method therefor, and a battery. More particularly, the present invention relates to a composite negative electrode for preparing a lithium metal battery, a method for preparing the composite negative electrode, and a lithium metal battery comprising the composite negative electrode.

### BACKGROUND

A lithium metal negative electrode, due to having a large theoretical specific capacity and a low electrochemical potential, is an extremely promising negative electrode material of a high energy density battery; however, lithium dendrites will occur in a lithium metal battery during the charging and discharging cycle, resulting in a short circuit.

In order to solve this problem, a lithium alloy is generally used to prevent the occurrence of lithium dendrites. However, a dead lithium phenomenon easily occurs in currently used lithium alloy negative electrode materials, which causes an interface reaction, and thus reduces the battery capacity. How to solve lithium dendrites and dead lithium phenomenon of a lithium metal battery during the charging and discharging cycle and ensure the capacity and cycle performance of a cell has become an urgent problem to be solved in the art.

### SUMMARY

The main object of the present invention is to provide a composite negative electrode and a method for preparing the composite negative electrode, so as to solve the problems of lithium dendrites and dead lithium during the charging and discharging cycle of a lithium metal battery in the prior art.

In order to achieve the described object, in one aspect, the present invention provides a composite negative electrode, wherein the composite negative electrode comprises a substrate and a negative electrode coating layer provided on the substrate, and the negative electrode coating layer comprises a first material and a second material, wherein the first material is a lithium-containing material, and in a direction away from the substrate along the composite negative electrode, the content of the lithium-containing material in at least part of the composite negative electrode gradually increases.

Further, in a direction away from the substrate along the composite negative electrode, the content of the second material in at least part of the composite negative electrode gradually decreases.

Further, in part of the composite negative electrode, the mass ratio of the lithium-containing material in the negative electrode coating varies with the coating thickness in the range of (1-5 wt %)/μm.

Further, the thickness of the negative electrode coating layer is d, and in the thickness direction of the negative electrode coating layer, in the range of 2% d-25% d from the substrate, the mass of the lithium-containing material is 10%-20% of the total mass of the lithium-containing material in the negative electrode coating layer; in the range of 25% d-40% d from the substrate, the mass of the lithium-containing material is 20%-50% of the total mass of the lithium-containing material in the negative electrode coating layer; and in the range of 40%-100% d from the substrate, the mass of the lithium-containing material is 40%-70% of the total mass of the lithium-containing material in the negative electrode coating layer.

Further, the lithium-containing material comprises one or more of lithium metal and a lithium alloy, and the lithium alloy comprises one or more of a lithium-silicon alloy and a lithium-carbon alloy.

Further, the second material comprises a carbon material and/or a silicon material, wherein the carbon material comprises one or more of natural graphite, synthetic graphite, soft carbon, hard carbon, carbon black, Ketjen carbon, acetylene black, Super P, grapheme, and single-walled carbon nanotubes, and wherein the silicon material comprises one or more of monocrystalline silicon, polycrystalline silicon, and amorphous silicon.

Further, the negative electrode coating layer further comprises an adhesive, and the adhesive comprises one or more of polyacrylic acid (PAA), styrene-butadiene rubber (SBR), polyvinylidene fluoride (PVDF), and carboxymethyl cellulose (CMC), and the mass ratio of the second material to the adhesive is 1.5-55.0.

Further, the negative electrode coating layer further comprises a conductive agent, and the conductive agent comprises a vapor grown carbon fiber (VGCF).

Further, the second material comprises silicon, graphite, and carbon nanotubes, and/or the mass ratio of the silicon to the graphite is 0.1-5.0, and the mass ratio of the silicon to the carbon nanotubes is 0.5-20.0.

In order to achieve the described object, another aspect of the present invention further provides a method for preparing the described composite negative electrode, the method comprising the following steps: step S1, providing a first material and a second material, wherein the first material is a lithium-containing material, and providing the second material on a substrate to form a second material layer; step S2, providing the first material on the second material layer to form a first lithium-containing material layer; and step S3, performing hot pressing on the first lithium-containing material layer and the second material layer, so as to obtain a composite negative electrode wherein in a direction away from the substrate along the composite negative electrode, the content of the lithium-containing material in at least part of the composite negative electrode gradually increases.

Further, the second material comprises one or more silicon material selected from monocrystalline silicon, polycrystalline silicon, and amorphous silicon, and the substrate is selected from a copper foil and a composite copper foil.

Further, the thickness of the first lithium-containing material layer is in the range of 5 μm to 30 μm, and/or the thickness of the second material layer is in the range of 10 μm to 60 μm.

Further, the average particle size (D50) of the second material is in the range of 1 μm to 40 μm.

Further, in step S3, the hot pressing is performed at a pressure of 10 Mpa to 40 Mpa at a temperature of 60° C. to 100° C.

Further, in step S3, the duration of the hot pressing lasts for 5 min to 30 min.

Further, the method further comprises: in step S2, pre-coating the lithium-containing material onto a PET film to form a lithium-containing film layer, and providing the lithium-containing film layer on the second material layer; and in step S3, after performing hot pressing, removing the PET film.

Further, the ratio of a thickness H₁ of the second material layer to a thickness H₂ of the first lithium-containing material layer satisfies 1<H₁/H₂≤10.

Further, a ratio of an area S₁ of the second material layer to an area S₂ of the first lithium-containing material layer satisfies 1.0<S₁/S₂≤1.5.

A further aspect of the present invention provides a lithium metal battery. The lithium metal battery comprises: a positive electrode, an electrolyte, and the composite negative electrode of the present invention or a composite negative electrode prepared by the method of the present invention.

### BRIEF DESCRIPTION OF THE DRAWINGS

The accompanying drawings, which form a part of the present application, are used to provide a further understanding of the present invention. The schematic examples of the present invention and the description thereof are used to explain the present invention, and do not form improper limits to the present invention. In the drawings:

FIG. 1 is a schematic diagram showing a gradient structure of a composite negative electrode according to an embodiment of the present invention;

FIG. 2 shows a schematic diagram of a method for preparing a composite negative electrode according to an embodiment of the invention; and

FIG. 3 shows changes in the discharge specific capacity and the coulomb efficiency during the charging and discharging cycle according to Example 3 of the present invention.

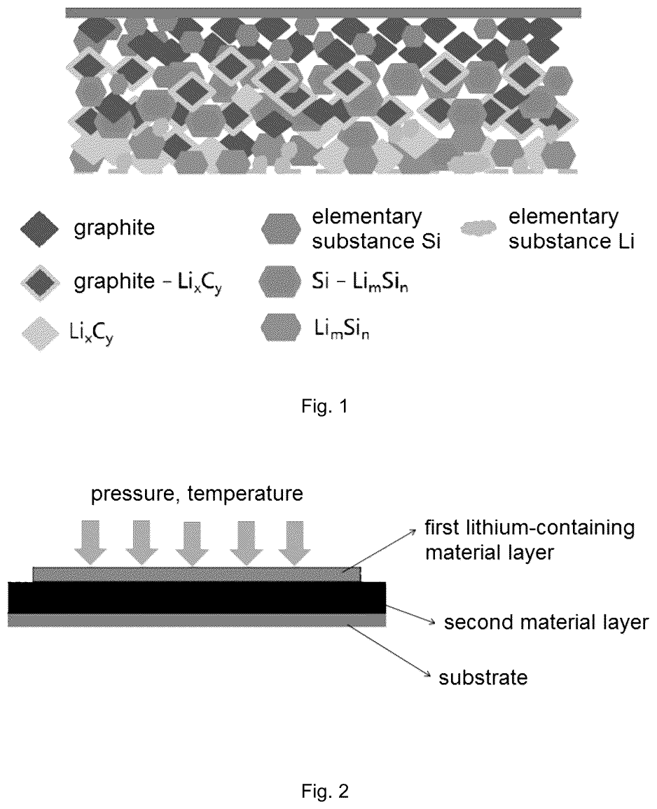

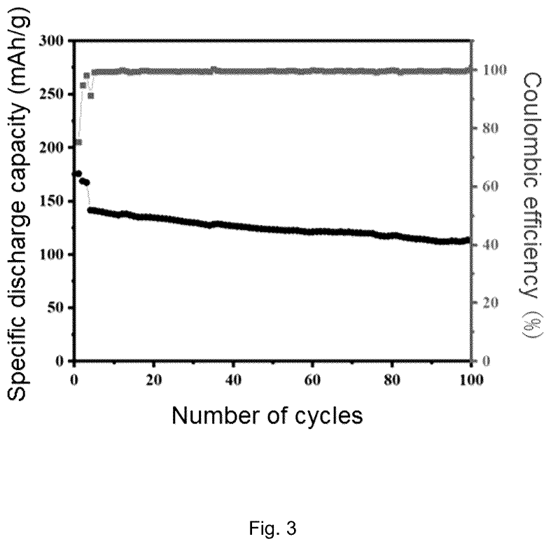

### DETAILED DESCRIPTION OF THE EMBODIMENTS

It is important to note that the examples of the present disclosure and the characteristics in the examples can be combined under the condition of no conflicts. Hereinafter, the present invention will be described in detail with reference to examples.

As described in the background art, the existing lithium metal batteries have a problem of lithium dendrites and dead lithium during the charging and discharging cycle. In order to solve the described technical problem, an embodiment of the present application provides a composite negative electrode, wherein the composite negative electrode comprises a substrate and a negative electrode coating layer provided on the substrate, and the negative electrode coating layer comprises a first material and a second material, wherein the first material is a lithium-containing material, and in a direction away from the substrate along the composite negative electrode, the content of the lithium-containing material in at least part of the composite negative electrode gradually increases.

The composite negative electrode of the present disclosure comprises a substrate and a negative electrode coating layer provided on the substrate, wherein the negative electrode coating layer comprises a lithium-containing material and a second material (such as silicon, graphite, and carbon nanotubes). In a direction away from the substrate along the composite negative electrode, the lithium-containing material in at least part of the composite negative electrode has a concentration gradient distribution, and the content of the lithium-containing material gradually increases. The innermost layer of the coating layer of the composite negative electrode in contact with the substrate has a low content of the lithium-containing material, and has the usually lowest point of the content of the lithium-containing material in the coating layer, thus ensuring that the coating layer is firmly bonded to the substrate while preventing lithium dendrite formation at the early stage of charge and discharge of the battery. In the thickness direction of the coating layer, i.e. the direction away from the substrate, the content of the lithium-containing material gradually increases.

With this structural design, lithium ions can be distributed more evenly during charging and discharging, the growth of lithium dendrites is effectively suppressed, and an internal short circuit of a battery caused by the lithium dendrites penetrating through a separator is avoided. Moreover, as the outer layer of the coating layer is rich in the lithium-containing material, the battery can also maintain stable performance under the condition of high-rate charge and discharge, thereby improving the cycle stability and rate performance of the battery.

Further, in a direction away from the substrate along the composite negative electrode, the content of the second material in at least part of the composite negative electrode gradually decreases. According to the composite negative electrode of the present invention, the content of the second material (such as a carbon material or a silicon material) is relatively high in the coating layer region close to the substrate, which helps to buffer the growth of lithium dendrites, and further provides structural support and improves the conductivity of the electrode. The increase of the content of the lithium-containing material in the coating layer region away from the substrate can make the region more suitable for the storage and release of lithium ions, which helps to withstand a higher charging and discharging current density, thereby further improving the rate performance of the battery.

Further, in part of the composite negative electrode, the mass ratio of the lithium-containing material in the negative electrode coating layer varies with the coating thickness in the range of (1-5 wt %)/μm. The variation gradient is 1 wt %/μm, 2 wt %/μm, 3 wt %/μm, 4 wt %/μm, 5 wt %/μm, etc. The variation gradient of the mass ratio of the lithium-containing material in the negative electrode coating layer with the coating thickness is within the range of the present disclosure, which can effectively inhibit the growth of lithium dendrites, reduce the risk of a short circuit, and further improve the safety of a battery. In addition, migration paths of lithium ions can also be improved, disordered diffusion of lithium ions at an interface can be reduced, interface impedance can be reduced, and the rate performance and charging and discharging efficiency of a battery can be further improved.

Further, the thickness of the negative electrode coating layer is d, and in the thickness direction of the negative electrode coating layer, in the range of 2% d-25% d from the substrate, the mass of the lithium-containing material is 10%-20% of the total mass of the lithium-containing material in the negative electrode coating layer; in the range of 25% d-40% d from the substrate, the mass of the lithium-containing material is 20%-50% of the total mass of the lithium-containing material in the negative electrode coating layer; and in the range of 40%-100% d from the substrate, the mass of the lithium-containing material is 40%-70% of the total mass of the lithium-containing material in the negative electrode coating layer.

Preferably, the thickness of the negative electrode coating layer is at most 50 μm, and in the thickness direction of the negative electrode coating layer, in the range of 1-12 μm from the substrate, the mass of the lithium-containing material is 10%-20% of the total mass of the lithium-containing material in the negative electrode coating layer; in the range of 12-20 μm from the substrate, the mass of the lithium-containing material is 20-50% of the total mass of the lithium-containing material in the negative electrode coating layer; and in the range of 20-45 μm from the substrate, the mass of the lithium-containing material is 40-70% of the total mass of the lithium-containing material in the negative electrode coating layer.

Further, the lithium-containing material comprises one or more of lithium metal and a lithium alloy, and the lithium alloy comprises one or more of a lithium-silicon alloy and a lithium-carbon alloy. The type of the lithium-containing material is within the range of the present disclosure, and the lithium element can provide lithium ion storage capability of the battery, which may help improve the initial capacity, cycle performance and safety of the battery. The lithium-containing material is preferably a lithium-silicon alloy or a lithium-carbon alloy. The lithium-silicon alloy has a relatively high theoretical specific capacity and a relatively low electrochemical potential, can further increase the energy density of a battery, and can further control the expansion rate of the material, and reduce the risk of structural damage during charging and discharging. In addition, the lithium-carbon alloy can stabilize the surface structure of a lithium metal negative electrode, reduce a side reaction with an electrolyte, and improve the cycle efficiency of a battery, and can also improve lithium ion intercalation and deintercalation processes, and thus further enhance the rate performance of the battery.

Further, the second material comprises a carbon material and/or a silicon material, wherein the carbon material comprises one or more of natural graphite, synthetic graphite, soft carbon, hard carbon, carbon black, Ketjen carbon, acetylene black, Super P, grapheme, and single-walled carbon nanotubes, and the silicon material therein comprises one or more of monocrystalline silicon, polycrystalline silicon, and amorphous silicon. The type of the carbon material is within the range of the present disclosure, and can not only serve as a good storage medium for lithium ions, but also provide good conductivity and structural stability. The type of the silicon material is within the range of the present disclosure, and can serve as an advantageous negative electrode material of a high energy density battery to reduce expansion and contraction during lithiation/delithiation and reduce structural damage to an electrode and degradation of battery performance.

Further, the negative electrode coating layer further comprises an adhesive, and the adhesive comprises one or more of polyacrylic acid (PAA), styrene-butadiene rubber (SBR), polyvinylidene fluoride (PVDF), and carboxymethyl cellulose (CMC), and the mass ratio of the second material to the adhesive is 1.5-55.0. For example, the mass ratio of the second material to the adhesive is 1.5, 3.0, 10.0, 15.0, 20.0, 30.0, 40.0, 50.0, 55.0, etc. The type of the adhesive and the mass ratio thereof are within the ranges of the present disclosure, which can maximize the utilization rate of the active material while ensuring the structural stability of the negative electrode coating layer, thereby further improving the overall performance of the battery. If the mass ratio is too low, internal impedance of the electrode may be increased, and utilization of the active material may be reduced, thereby affecting capacity and rate performance of the battery. If the mass ratio is too high, the bonding force between the second material layer and the substrate may be insufficient, and the electrode may easily fall off during charging and discharging, thereby affecting the cycling stability and safety of the battery.

Further, the negative electrode coating layer further comprises a conductive agent, and the conductive agent comprises a vapor grown carbon fiber (VGCF). By adding the conductive agent, such as VGCF, to the second material layer, not only the electronic and ionic conductivity of the second material layer can be improved, but also the structural stability and overall performance thereof can be enhanced.

Further, the second material comprises silicon, graphite, and carbon nanotubes, the mass ratio of the silicon to the graphite is 0.1-5.0, and the mass ratio of the silicon to the carbon nanotubes is 0.5-20.0. For example, the mass ratio of the silicon to the graphite is 0.1, 0.5, 1.0, 3.0, 5.0, etc. For example, the mass ratio of the silicon to the carbon nanotubes is 0.5, 1.0, 5.0, 10.0, 15.0, 20.0, etc. The mass ratio of the silicon to the graphite and the mass ratio of the silicon to the carbon nanotubes within the ranges of the present disclosure can inhibit volume expansion during charging and discharging and improve the mechanical strength and electronic conductivity of the second material layer, and can also effectively prevent the growth of lithium dendrites, reduce the direct contact between the electrolyte and lithium metal, and further ensure the stability and long cycle life of the cell under high-rate charging and discharging conditions.

Another embodiment of the present application provides a method for preparing the described composite negative electrode, the method comprising the following steps: step S1, providing a first material and a second material, wherein the first material is a lithium-containing material, and providing the second material on a substrate to form a second material layer; step S2, providing the first material on the second material layer to form a first lithium-containing material layer; and step S3, performing hot pressing on the first lithium-containing material layer and the second material layer, so as to obtain a composite negative electrode wherein in a direction away from the substrate along the composite negative electrode, the content of the lithium-containing material in at least part of the composite negative electrode gradually increases

By further providing a first lithium-containing material layer on a second material layer on a substrate, and performing a hot pressing treatment on the bonded first material layer and second material layer, a composite negative electrode wherein the content of the lithium-containing material gradually increases in at least part of the composite negative electrode can be obtained. The first lithium-containing material layer and the second material layer are bonded and subjected to a hot pressing treatment, so that close contact between the materials and formation of a gradient structure can be achieved. The hot pressing treatment can promote a chemical reaction between the first lithium-containing material and the second material (carbon and silicon material), so as to form a structure wherein the content of the lithium-containing material gradually increases in a direction away from the substrate along the composite negative electrode. The composite negative electrode having such a concentration change can effectively prevent lithium dendrite formation, suppress the dead lithium phenomenon, reduce interface impedance at the same time, and finally improve the cycle performance and rate performance of a battery. In addition, the preparation method of the present invention is simple and easy to operate, thereby further improving the production efficiency.

Further, the second material comprises one or more silicon material selected from monocrystalline silicon, polycrystalline silicon, and amorphous silicon, and the substrate is selected from a copper foil (for example, an electrolytic copper foil) and a composite copper foil. The type of the silicon material is within the range of the present disclosure, and can serve as an advantageous negative electrode material of a high energy density battery to reduce expansion and contraction during lithiation/delithiation and reduce structural damage to an electrode and degradation of battery performance.

Further, the thickness of the first lithium-containing material layer is in the range of 5 μm to 30 μm, and/or the thickness of the second material layer is in the range of 10 μm to 60 μm. For example, the first lithium-containing material layer has a thickness of 5 μm, 6 μm, 7 μm, 8 μm, 9 μm, 10 μm, 12 μm, 15 μm, 18 μm, 20 μm, 22 μm, 25 μm, 28 μm, or 30 μm. For example, the thickness of the second material layer is 10 μm, 15 μm, 20 μm, 25 μm, 30 μm, 35 μm, 40 μm, 45 μm, 50 μm, 55 μm, or 60 μm. If the thickness of the first lithium-containing material layer is too thin, a sufficient storage amount of lithium ions may not be provided, thereby limiting the capacity of the battery. On the contrary, if the thickness is too large, the internal impedance of the battery may be increased, thereby affecting the rate performance and charging and discharging efficiency of the battery. A excessively thin second material layer may not effectively inhibit the growth of lithium dendrites, and also cannot provide enough buffer space to adapt to the volume change of the silicon material. An excessively thick second material layer may increase the thickness of a cell, reduce energy density, increase internal impedance of a battery, and affect rate performance.

Further, the average particle size (D50) of the second material is in the range of 1 μm to 40 μm. Preferably, the second material is a silicon material and the average particle size (D50) of the silicon material is in the range of 1 μm to 20 μm. For example, the average particle size (D50) of the second material is 1 μm, 5 μm, 8 μm, 10 μm, 12 μm, 15 μm, 18 μm, 20 μm, 25 μm, 30 μm, 35 μm or 40 μm. The average particle size (D50) of the second material within the range of the present disclosure can provide a sufficient surface area and volume ratio, facilitate rapid intercalation and deintercalation of lithium ions, and further improve the rate performance of the battery. Too small an average particle size (D50) will increase the manufacturing costs and operation difficulty of the material, and too large an average particle size (D50) will decrease the lithium ion diffusion rate of the electrode, affecting the cycle stability and rate performance of the battery.

Further, in step S3, the hot pressing is performed at a pressure of 10 Mpa to 40 Mpa at a temperature of 60° C. to 100° C.

For example, during hot pressing, the pressure selected is 10 MPa, 15 MPa, 20 MPa, 25 MPa, 30 MPa, 35 MPa, 40 MPa, etc. The pressure value during the hot pressing within the range of the present disclosure can effectively promote the close contact and bonding between the first lithium-containing material layer and the second material layer (the material comprising silicon, graphite, carbon nanotubes, etc.) to form a stable interface, and can also ensure that the material layer forms a gradient structure in the thickness direction, and can further prevent the internal structure of the material layer from being damaged due to an excessive pressure. In this way, lithium dendrite and dead lithium problems of the lithium metal battery during the charging and discharging cycle can be avoided, and the cycle stability and rate performance of the battery are further improved.

For example, the temperature selected for performing hot pressing is 60° C., 65° C., 70° C., 75° C., 80° C., 85° C., 90° C., 95° C., 100° C., etc. The temperature during the hot pressing within the range of the present disclosure can facilitate the diffusion and reaction inside the materials, facilitate the formation of a lithium-silicon alloy and a lithium-carbon alloy, and help to form a gradient structure, and can also improve the adhesiveness of the material layer and enhance the mechanical strength of the composite material. The temperature of the present invention can balance the thermal stability of the material with the reaction activity in the hot pressing process, and ensure that the formation of a gradient structure does not cause degradation of the performance of the material. In this way, lithium dendrite and dead lithium problems of the lithium metal battery during charging and discharging cycle can be avoided, and cycle stability and rate performance of the battery are further improved.

Further, in step S3, the duration of the hot pressing lasts for 5 min to 30 min. For example, the duration of the hot pressing lasts for 5 min, 6 min, 7 min, 8 min, 9 min, 10 min, 15 min, 20 min, 25 min, 30 min, etc. The hot pressing time is within the range of the present disclosure, and can improve the bonding strength between material layers and the formation of a change in the concentration of an active material, control the production costs, and finally further improve the battery performance.

Further, the method further comprises: in step S2, pre-coating the lithium-containing material onto a PET (polyethylene terephthalate) film to form a lithium-containing film layer, and providing the lithium-containing film layer on a second material layer; and in step S3, after performing hot pressing, removing the PET film.

Further, the ratio of a thickness H₁ of the second material layer to a thickness H₂ of the first lithium-containing material layer satisfies 1<H₁/H₂≤10. For example, H₁/H₂ is 1, 2, 3, 4, 5, 6, 7, 8, 9, 10, etc. The ratio of the thickness H₁ of the second material layer to the thickness H₂ of the first lithium-containing material layer is within the range of the present disclosure. The thickness of the second material layer (for example, a material comprising carbon and silicon) is larger than that of the first lithium-containing material layer, which can further increase the effective capacity of the negative electrode and the energy density of the battery, thereby improving the overall capacity of the battery.

Further, the ratio of an area S₁ of the second material layer to an area S₂ of the first lithium-containing material layer satisfies 1.0<S₁/S₂≤1.5. For example, S_{C}/S_{Li} is 1.0, 1.1, 1.2, 1.3, 1.4, 1.5, etc. when S₁/S₂ is within the scope of the present disclosure, the area of the second material layer can be appropriately expanded, so that the uniform distribution and reaction of lithium ions in the charging and discharging process can be ensured, and a locally too high concentration and current density of the lithium ions are avoided, thereby further reducing the formation of lithium dendrites and the occurrence of dead lithium phenomenon and further improving the cycle stability and safety of a battery.

Another embodiment of the present application provides a lithium metal battery. The lithium metal battery comprises a positive electrode, an electrolyte, and the composite negative electrode or the composite negative electrode prepared by the described method.

The present disclosure will be further described in detail with reference to the following examples, which should not be construed as limiting the scope of protection of the present disclosure.

In the following examples, the lithium content in the negative electrode coating layer was determined by XRF (i.e. X-ray fluorimeter). Specifically, a prepared negative electrode sheet was taken and cut along the thickness direction of the electrode sheet to obtain to-be-measured slices of regions having different thicknesses of the negative electrode sheet, the surface was flattened by tabletting, and the to-be-measured slices had a size of 40-50 mm and a thickness of 30-40 μm, wherein, a standard sample was a lithium-silicon alloy slice having a lithium content of 50%, and the lithium content of the to-be-measured slices was analyzed quantitatively by measuring the energy and strength of XRF.

### Example 1

Step S1: Graphite, polyacrylic acid (PAA), and deionized water were added to micro monocrystalline silicon and single-walled carbon nanotubes having an average particle size (D50) of about 1 μm, and subjected to homogenization treatment to obtain a uniformly mixed silicon-carbon material. In the silicon-carbon material, the mass ratio of the micro silicon to the graphite was 0.1, the mass ratio of the micro silicon to the carbon nanotubes was 0.5, and the mass ratio of the second material (i.e. a mixture of the micro silicon, the graphite and the carbon nanotubes, which will not be further described below) to PAA was 1.5. The uniformly mixed silicon-carbon material was uniformly coated on a copper foil to form a silicon-carbon layer, the thickness of the silicon-carbon layer being 10 μm;

Step S2: After drying the silicon-carbon layer obtained in step S1, lithium coated on a PET (polyethylene terephthalate) film was imprinted onto the surface of the silicon-carbon layer, and the PET film was removed to form a lithium layer having a thickness of 5 μm;

Step S3: The silicon-carbon layer and the lithium layer were subjected to hot pressing, and during hot pressing, the pressure was controlled to be 10 MPa, the temperature was controlled to be 60° C., and the duration was controlled to be 30 min, so as to obtain a composite negative electrode having a gradually increasing lithium content in a direction away from the copper foil. In the composite negative electrode, the thickness of the negative electrode coating layer was 12 μm, and in the thickness direction of the negative electrode coating layer, in the range of 0.24-3 μm from the copper foil, the mass of lithium was 15% of the total mass of lithium in the negative electrode coating layer; in the range of 3-4.8 μm from the copper foil, the mass of lithium was 25% of the total mass of lithium in the negative electrode coating layer; and in the range of 4.8-12 μm from the copper foil, the mass of lithium was 60% of the total mass of lithium in the negative electrode coating layer.

### Example 2

Step S1: Graphite, carboxymethyl cellulose (CMC), and deionized water were added to micro monocrystalline silicon and single-walled carbon nanotubes having an average particle size (D50) of about 1 μm, and subjected to homogenization treatment to obtain a uniformly mixed silicon-carbon material. In the silicon-carbon material, the mass ratio of the micro silicon to the graphite was 1, the mass ratio of the micro silicon to the carbon nanotubes was 2, and the mass ratio of the second material to CMC was 5. The uniformly mixed silicon-carbon material was uniformly coated on a copper foil to form a silicon-carbon layer, the thickness of the silicon-carbon layer being 60 μm.

Step S2: After drying the silicon-carbon layer obtained in step S1, lithium coated on a PET film was imprinted onto the surface of the silicon-carbon layer, and the PET film was removed to form a lithium layer having a thickness of 30 μm.

Step S3: The silicon-carbon layer and the lithium layer were subjected to hot pressing, and during hot pressing, the pressure was controlled to be 20 MPa, the temperature was controlled to be 100° C., and the duration was controlled to be 5 min, so as to obtain a composite negative electrode having a gradually increasing lithium content in a direction away from the copper foil. In the composite negative electrode, the thickness of the negative electrode coating layer was 72 μm, and in the thickness direction of the negative electrode coating layer, in the range of 1.44-18 μm from the copper foil, the mass of lithium was 18% of the total mass of lithium in the negative electrode coating layer; in the range of 18-28.8 μm from the copper foil, the mass of lithium was 31% of the total mass of lithium in the negative electrode coating layer; and in the range of 28.8-72 μm from the copper foil, the mass of lithium was 51% of the total mass of lithium in the negative electrode coating layer.

### Example 3

Step S1: Graphite, polyacrylic acid (PAA), and deionized water were added to micro monocrystalline silicon and single-walled carbon nanotubes having an average particle size (D50) of about 1 μm, and subjected to homogenization treatment to obtain a uniformly mixed silicon-carbon material. In the silicon-carbon material, the mass ratio of the micro silicon to the graphite was 3, the mass ratio of the micro silicon to the carbon nanotubes was 8, and the mass ratio of the second material to PAA was 10. The uniformly mixed silicon-carbon material was uniformly coated on a copper foil to form a silicon-carbon layer, the thickness of the silicon-carbon layer being 40 μm.

Step S2: After drying the silicon-carbon layer obtained in step S1, lithium coated on a PET film was imprinted onto the surface of the silicon-carbon layer, and the PET film was removed to form a lithium layer having a thickness of 20 μm.

Step S3: The silicon-carbon layer and the lithium layer were subjected to hot pressing, and during hot pressing, the pressure was controlled to be 40 MPa, the temperature was controlled to be 80° C., and the duration was controlled to be 15 min, so as to obtain a composite negative electrode having a gradually increasing lithium content in a direction away from the copper foil. In the composite negative electrode, the thickness of the negative electrode coating layer was 48 μm, and in the thickness direction of the negative electrode coating layer, in the range of 0.96-12 μm from the copper foil, the mass of lithium was 12% of the total mass of lithium in the negative electrode coating layer; in the range of 12-19.2 μm from the copper foil, the mass of lithium was 33% of the total mass of lithium in the negative electrode coating layer; and in the range of 19.2-48 μm from the copper foil, the mass of lithium was 55% of the total mass of lithium in the negative electrode coating layer.

### Example 4

Step S1: Graphite, polyvinylidene fluoride (PVDF), and deionized water were added to micro monocrystalline silicon and single-walled carbon nanotubes having an average particle size (D50) of about 1 μm, and subjected to homogenization treatment to obtain a uniformly mixed silicon-carbon material. In the silicon-carbon material, the mass ratio of the micro silicon to the graphite was 4, the mass ratio of the micro silicon to the carbon nanotubes was 15, and the mass ratio of the second material to PVDF was 20. The uniformly mixed silicon-carbon material was uniformly coated on a copper foil to form a silicon-carbon layer, the thickness of the silicon-carbon layer being 30 μm.

Step S2: After drying the silicon-carbon layer obtained in step S1, lithium coated on a PET film was imprinted onto the surface of the silicon-carbon layer, and the PET film was removed to form a lithium layer having a thickness of 20 μm.

Step S3: The silicon-carbon layer and the lithium layer were subjected to hot pressing, and during hot pressing, the pressure was controlled to be 30 MPa, the temperature was controlled to be 85° C., and the duration was controlled to be 10 min, so as to obtain a composite negative electrode having a gradually increasing lithium content in a direction away from the copper foil. In the composite negative electrode, the thickness of the negative electrode coating layer was 40 μm, and in the thickness direction of the negative electrode coating layer, in the range of 0.8-10 μm from the copper foil, the mass of lithium was 10% of the total mass of lithium in the negative electrode coating layer; in the range of 10-16 μm from the copper foil, the mass of lithium was 23% of the total mass of lithium in the negative electrode coating layer; and in the range of 16-40 μm from the copper foil, the mass of lithium was 67% of the total mass of lithium in the negative electrode coating layer.

### Example 5

Step S1: Graphite, styrene-butadiene rubber (SBR), and deionized water were added to micro monocrystalline silicon and single-walled carbon nanotubes having an average particle size (D50) of about 1 μm, and subjected to homogenization treatment to obtain a uniformly mixed silicon-carbon material. In the silicon-carbon material, the mass ratio of the micro silicon to the graphite was 5, the mass ratio of the micro silicon to the carbon nanotubes was 20, and the mass ratio of the second material to SBR was 55. The uniformly mixed silicon-carbon material was uniformly coated on a copper foil to form a silicon-carbon layer, the thickness of the silicon-carbon layer being 40 μm.

Step S2: After drying the silicon-carbon layer obtained in step S1, lithium coated on a PET film was imprinted onto the surface of the silicon-carbon layer, and the PET film was removed to form a lithium layer having a thickness of 10 μm.

Step S3: The silicon-carbon layer and the lithium layer were subjected to hot pressing, and during hot pressing, the pressure was controlled to be 40 MPa, the temperature was controlled to be 70° C., and the duration was controlled to be 20 min, so as to obtain a composite negative electrode having a gradually increasing lithium content in a direction away from the copper foil. In the composite negative electrode, the thickness of the negative electrode coating layer was 40 μm, and in the thickness direction of the negative electrode coating layer, in the range of 0.8-10 μm from the copper foil, the mass of lithium was 20% of the total mass of lithium in the negative electrode coating layer; in the range of 10-16 μm from the copper foil, the mass of lithium was 36% of the total mass of lithium in the negative electrode coating layer; and in the range of 16-40 μm from the copper foil, the mass of lithium was 44% of the total mass of lithium in the negative electrode coating layer.

### Example 6

A composite electrode was prepared in the same manner as that in Example 1, except that the hot pressing process of step S3 was not applied to the lithium layer and the silicon-carbon layer, and a roller pressing process of 2 MPa was applied only at room temperature for 5 min. In the obtained composite negative electrode, the thickness of the negative electrode coating layer was 14 μm, and in the thickness direction of the negative electrode coating layer, in the range of 0.28-3.5 μm from the copper foil, the mass of lithium was 0% of the total mass of lithium in the negative electrode coating layer; in the range of 3.5-5.6 μm from the copper foil, the mass of lithium was 0% of the total mass of lithium in the negative electrode coating layer; and in the range of 5.6-14 μm from the copper foil, the mass of lithium was 100% of the total mass of lithium in the negative electrode coating layer.

### Example 7

A composite electrode was prepared in the same manner as that in Example 1, except that in step S1, the mass ratio of the micro silicon to the graphite was 0.05, the mass ratio of the micro silicon to the carbon nanotubes was 0.1, and the mass ratio of the second material to PAA was 1. In the obtained composite negative electrode, the thickness of the negative electrode coating layer was 12 μm, and in the thickness direction of the negative electrode coating layer, in the range of 0.24-3 μm from the copper foil, the mass of lithium was 8% of the total mass of lithium in the negative electrode coating layer; in the range of 3-4.8 μm from the copper foil, the mass of lithium was 10% of the total mass of lithium in the negative electrode coating layer; and in the range of 4.8-12 μm from the copper foil, the mass of lithium was 81% of the total mass of lithium in the negative electrode coating layer.

### Example 8

A composite electrode was prepared in the same manner as that in Example 1, except that in step S1, the mass ratio of the micro silicon to the graphite was 8, the mass ratio of the micro silicon to the carbon nanotubes was 25, and the mass ratio of the second material to PAA was 60. In the obtained composite negative electrode, the thickness of the negative electrode coating layer was 12 μm, and in the thickness direction of the negative electrode coating layer, in the range of 0.24-3 μm from the copper foil, the mass of lithium was 5% of the total mass of lithium in the negative electrode coating layer; in the range of 3-4.8 μm from the copper foil, the mass of lithium was 6% of the total mass of lithium in the negative electrode coating layer; and in the range of 4.8-12 μm from the copper foil, the mass of lithium was 89% of the total mass of lithium in the negative electrode coating layer.

### Example 9

A composite electrode was prepared in the same manner as that in Example 1, except that in step S3, during hot pressing, the pressure was controlled to be 5 Mpa, the temperature was controlled to be 50° C., and the duration was controlled to be 3 min. In the obtained composite negative electrode, the thickness of the negative electrode coating layer was 12 μm, and in the thickness direction of the negative electrode coating layer, in the range of 0.24-3 μm from the copper foil, the mass of lithium was 7% of the total mass of lithium in the negative electrode coating layer; in the range of 3-4.8 μm from the copper foil, the mass of lithium was 11% of the total mass of lithium in the negative electrode coating layer; and in the range of 4.8-12 μm from the copper foil, the mass of lithium was 82% of the total mass of lithium in the negative electrode coating layer.

### Example 10

A composite electrode was prepared in the same manner as that in Example 1, except that in step S3, during hot pressing, the pressure was controlled to be 8 Mpa, the temperature was controlled to be 80° C., and the duration was controlled to be 3 min. In the obtained composite negative electrode, the thickness of the negative electrode coating layer was 12 μm, and in the thickness direction of the negative electrode coating layer, in the range of 0.24-3 μm from the copper foil, the mass of lithium was 8% of the total mass of lithium in the negative electrode coating layer; in the range of 3-4.8 μm from the copper foil, the mass of lithium was 9% of the total mass of lithium in the negative electrode coating layer; and in the range of 4.8-12 μm from the copper foil, the mass of lithium was 83% of the total mass of lithium in the negative electrode coating layer.

### Example 11

A composite electrode was prepared in the same manner as that in Example 1, except that in step S3, during hot pressing, the pressure was controlled to be 10 Mpa, the temperature was controlled to be room temperature, and the duration was controlled to be 5 min. In the obtained composite negative electrode, the thickness of the negative electrode coating layer was 12 μm, and in the thickness direction of the negative electrode coating layer, in the range of 0.24-3 μm from the copper foil, the mass of lithium was 6% of the total mass of lithium in the negative electrode coating layer; in the range of 3-4.8 μm from the copper foil, the mass of lithium was 10% of the total mass of lithium in the negative electrode coating layer; and in the range of 4.8-12 μm from the copper foil, the mass of lithium was 84% of the total mass of lithium in the negative electrode coating layer.

### Example 12

A composite electrode was prepared in the same manner as that in Example 1, except that in step S3, during hot pressing, the pressure was controlled to be 2 Mpa, the temperature was controlled to be 60° C., and the duration was controlled to be 5 min. In the obtained composite negative electrode, the thickness of the negative electrode coating layer was 12 μm, and in the thickness direction of the negative electrode coating layer, in the range of 0.24-3 μm from the copper foil, the mass of lithium was 6% of the total mass of lithium in the negative electrode coating layer; in the range of 3-4.8 μm from the copper foil, the mass of lithium was 9% of the total mass of lithium in the negative electrode coating layer; and in the range of 4.8-12 μm from the copper foil, the mass of lithium was 85% of the total mass of lithium in the negative electrode coating layer.

### Performance Testing

### I. Preparation of a Battery

Preparation of a button battery: A ternary positive electrode material was coated on the surface of a carbon-coated aluminium foil with the thickness of the coating layer being 30 μm, and then prepared into a positive electrode button electrode sheet having a diameter d of 16 mm, and an electrolyte membrane having a diameter d of 18 mm and a negative electrode button electrode sheet having a diameter d of 19 mm were used. Then, the positive electrode and the electrolyte membrane were first subjected to hydraulic pressing at 50 MPa for 15 min and hot pressing at 50 T for 30 min. Then, a silicon-carbon composite negative electrode was bonded and subjected to a process comprising hydraulic pressing at 50 MPa for 15 min and hot pressing at 50 T for 30 min to prepare a button battery, wherein the battery is 2016 model. The following performance tests were all conducted under conditions of 55° C.

The composite negative electrode sheet obtained by the process according to any one of Examples 1-12 was used as the described button electrode sheet.

### II. Performance Testing

### (1) Cycle Performance Test

The batteries were charged and discharged at a constant current of 0.1 C for the first two cycles to activate the batteries, and then the cycle performance was tested at a current of 0.33 C. When the specific capacity of the curve fluctuated greatly and the battery capacity retention ratio was lower than 80%, it indicated that the batteries had failed.

### (2) Rate Performance Test

The batteries were charged and discharged twice at a current of 0.05 C to activate the batteries, and then the batteries prepared in the examples were tested for rate performance with currents of 0.5 C and 1 C, respectively.

The batteries were charged and discharged at different rates. If the batteries were cycled at least 80 times and the capacity retention ratio was still greater than or equal to 80%, they were considered as valid batteries. If the capacity retention ratio of the batteries was lower than 80%, the batteries were considered to be failed.

### (3) First Coulombic Efficiency Test

The prepared all-solid button cell was charged to 4.25 V at a constant current of 0.1 C, and then discharged to 2.5 V at a constant current of 0.1 C, and the first coulombic efficiency was obtained by calculating the ratio of the first discharge capacity to the first charge capacity.

The performance test results of the described examples are shown in Table 1.

| | | First | Rate performance | | |
|---|---|---|---|---|---|
| | Number of | columbic | | | Capacity |
| | cycles | efficiency | | Number of | retention |
| No. | (0.33 C) | (0.1 C) | Rate | cycles | ratio |
| Example 1 | 90 | 81% | 0.5 C | 80 | 82% |
| | | | 1 C | 70 | 80% |
| Example 2 | 97 | 82% | 0.5 C | 84 | 83% |
| | | | 1 C | 73 | 78% |
| Example 3 | 100 | 89% | 0.5 C | 95 | 89% |
| | | | 1 C | 90 | 82% |
| Example 4 | 95 | 80% | 0.5 C | 93 | 88% |
| | | | 1 C | 80 | 75% |
| Example 5 | 93 | 82% | 0.5 C | 94 | 86% |
| | | | 1 C | 78 | 82% |
| Example 6 | 80 | 75% | 0.5 C | 75 | 79% |
| | | | 1 C | 66 | 76% |
| Example 7 | 65 | 73% | 0.5 C | 83 | 80% |
| | | | 1 C | 70 | 75% |
| Example 8 | 70 | 77% | 0.5 C | 86 | 85% |
| | | | 1 C | 73 | 79% |
| Example 9 | 75 | 74% | 0.5 C | 88 | 86% |
| | | | 1 C | 75 | 82% |
| Example | 76 | 78% | 0.5 C | 87 | 83% |
| 10 | | | 1 C | 70 | 72% |
| Example | 70 | 73% | 0.5 C | 70 | 85% |
| 11 | | | 1 C | 60 | 70% |
| Example | 74 | 78% | 0.5 C | 65 | 88% |
| 12 | | | 1 C | 55 | 75% |

The data of the number of cycles (0.33 C) shown in Table 1 shows the number of charging and discharging cycles when the capacity retention ratio of the battery is 80% and the battery was subjected to charging and discharging cycle test at a current of 0.33 C.

From the description above, it can be determined that the battery prepared by the composite electrode prepared by the method of the present invention has excellent battery cycle performance, first Coulomb efficiency and rate performance.

It should be noted that terms such as “first” and “second” in the description and claims of the present application are used to distinguish similar objects, and are not necessarily used to describe a specific sequence or order. It should be understood that the terms so used are interchangeable under appropriate circumstances such that the embodiments of the present application described herein can, for example, be practiced in sequences other than those described herein.

The description above is only the preferred examples of the present invention, and is not intended to limit the present invention. For a person skilled in the art, the present invention may have various modifications and variations. Any modifications, equivalent replacements, improvements and the like made within the spirit and principle of the present invention shall fall within the scope of protection of the present invention.

1. A composite negative electrode, wherein the composite negative electrode comprises a substrate and a negative electrode coating layer provided on the substrate, the negative electrode coating layer comprises a first material and a second material, wherein the first material is a lithium-containing material, and in a direction away from the substrate along the composite negative electrode, the content of the lithium-containing material in at least part of the composite negative electrode gradually increases.

2. The composite negative electrode of claim 1, wherein in a direction away from the substrate along the composite negative electrode, the content of the second material in at least part of the composite negative electrode gradually decreases.

3. The composite negative electrode of claim 1, wherein in part of the composite negative electrode, the mass ratio of the lithium-containing material in the negative electrode coating layer varies with the coating thickness in a gradient of (1-5 wt %)/μm.

4. The composite negative electrode of claim 1, wherein the thickness of the negative electrode coating layer is d, and in the thickness direction of the negative electrode coating layer, in the range of 2% d-25% d from the substrate, the mass of the lithium-containing material is 10%-20% of the total mass of the lithium-containing material in the negative electrode coating layer; in the range of 25% d-40% d from the substrate, the mass of the lithium-containing material is 20%-50% of the total mass of the lithium-containing material in the negative electrode coating layer; and in the range of 40%-100% d from the substrate, the mass of the lithium-containing material is 40%-70% of the total mass of the lithium-containing material in the negative electrode coating layer.

5. The composite negative electrode of claim 1, wherein the lithium-containing material comprises one or more of lithium metal and a lithium alloy, and the lithium alloy comprises one or more of a lithium-silicon alloy and a lithium-carbon alloy.

6. The composite negative electrode of claim 1, wherein the second material comprises a carbon material and/or a silicon material,
wherein the carbon material comprises one or more of natural graphite, synthetic graphite, soft carbon, hard carbon, carbon black, Ketjen black, acetylene black, Super P, graphene, and single-walled carbon nanotubes,
wherein the silicon material comprises one or more of single crystalline silicon, polycrystalline silicon, and amorphous silicon.

7. The composite negative electrode of claim 1, wherein the negative electrode coating layer further comprises an adhesive,
the adhesive comprises one or more of polyacrylic acid (PAA), styrene-butadiene rubber (SBR), polyvinylidene fluoride (PVDF), and carboxymethyl cellulose (CMC), and
the mass ratio of the second material to the adhesive is 1.5-55.0.

8. The composite negative electrode of claim 1, wherein the negative electrode coating layer further comprises a conductive agent, and the conductive agent comprises a vapor grown carbon fiber (VGCF).

9. The composite negative electrode of claim 1, wherein the second material comprises silicon, graphite, and carbon nanotubes, and/or the mass ratio of the silicon to the graphite is 0.1-5.0, and the mass ratio of the silicon to the carbon nanotubes is 0.5-20.0.

10. A method for producing the composite negative electrode of claim 1, wherein the method comprises the following steps:
step S1, providing a first material and a second material, wherein the first material is a lithium-containing material, and providing the second material on a substrate to form a second material layer;
step S2, providing the first material on the second material layer to form a first lithium-containing material layer; and
step S3, performing hot pressing on the first lithium-containing material layer and the second material layer, so as to obtain a composite negative electrode wherein in a direction away from the substrate along the composite negative electrode, the content of the lithium-containing material in at least part of the composite negative electrode gradually increases.

11. The method of claim 10, wherein the second material comprises one or more silicon material selected from monocrystalline silicon, polycrystalline silicon, and amorphous silicon, and the substrate is selected from a copper foil and a composite copper foil.

12. The method of claim 10, wherein the first lithium-containing material layer has a thickness in the range of 5 μm to 30 μm, and/or the second material layer has a thickness in the range of 10 μm to 60 μm.

13. The method of claim 10, wherein the average particle size (D50) of the second material is in the range of 1 μm to 40 μm.

14. The method of claim 10, wherein, in step S3, the hot pressing is performed at a pressure of 10 MPa to 40 MPa at a temperature of 60° C. to 100° C.

15. The method of claim 10, wherein, in step S3, the duration of the hot pressing lasts 5 min to 30 min.

16. The method of claim 10, wherein the method further comprises: in step S2, pre-coating the lithium-containing material onto a PET film to form a lithium-containing film layer, and providing the lithium-containing film layer on the second material layer; and in step S3, after performing hot pressing, removing the PET film.

17. The method of claim 10, wherein the ratio of a thickness H₁ of the second material layer to a thickness H₂ of the first lithium-containing material layer satisfies 1<H₁/H₂≤10.

18. The method of claim 10, wherein the ratio of an area S₁ of the second material layer to an area S₂ of the first lithium-containing material layer satisfies 1.0<S₁/S₂≤1.5.

19. A lithium metal battery, wherein the lithium metal battery comprises:
a positive electrode,
an electrolyte, and
the composite negative electrode of claim 1.
